(19) United States
(12) Patent Application Publication
(10) Pub. No.: US 2016/0085498 A1
(43) Pub. Date: Mar. 24, 2016

(54) METHOD AND APPARATUS FOR MUTING A DEVICE

(71) Applicant: MOTOROLA SOLUTIONS, INC., Schaumburg, IL (US)

(72) Inventors: KONG CHIN CHEE, BAYAN BARU (MY); KOK BEE LEE, PULAU PINANG (MY); SZE KEAT NG, SUNGAI PETANI (MY); RM MUTHAIAH RAMANATHAN, JELUTONG (MY); SYED ISA SYED IDRUS, BAYAN LEPAS (MY)

(21) Appl. No.: 14/495,214

(22) Filed: Sep. 24, 2014

(51) Int. Cl. G06F 3/16; G10L 25/93

(52) U.S. Cl. CPC G06F 3/165; G10L 25/93

(57) ABSTRACT

A method and apparatus for muting a device is provided herein. During operation a device such as a two-way radio detects a user's voice and will mute the radio in response to the voice being detected. During the time period the device is muted, all received transmissions will be stored by the radio. These transmissions will be played back to the user when voice activity has ceased for a predetermined amount of time. In a second embodiment of the present invention, the device is only muted when a particular identified user's voice is detected.

### FIELD OF THE INVENTION

The present invention generally relates to muting a device, and more particularly to a method and apparatus for muting a device based on a detection of a user's voice.

### BACKGROUND OF THE INVENTION

First responders are often in communication with individuals they are dispatched to aide. For example, paramedics may need to communicate with a patient in order to determine an extent of an injury. During communications with individuals, the paramedic's radio may continue receiving voice communications and outputting the received communications to a speaker, making it difficult to hear what the patient is saying. This situation is exaggerated when a first responder is wearing a headset connected to their radio. Therefore, a need exists for a method and apparatus for muting a device so that communications with individuals may be improved.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operating environment.

FIG. 2 is a block diagram of the device of FIG. 1.

FIG. 3 is a flow chart showing operation of the device of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above mentioned need, a method and apparatus for muting a device is provided herein. During operation a device such as a two-way radio detects a user's voice and will mute the radio in response to the voice being detected. During the time period the device is muted, all received transmissions will be stored by the radio. These transmissions will be played back to the user when voice activity has ceased for a predetermined amount of time. In a second embodiment of the present invention, the device is only muted when a particular identified user's voice is detected.

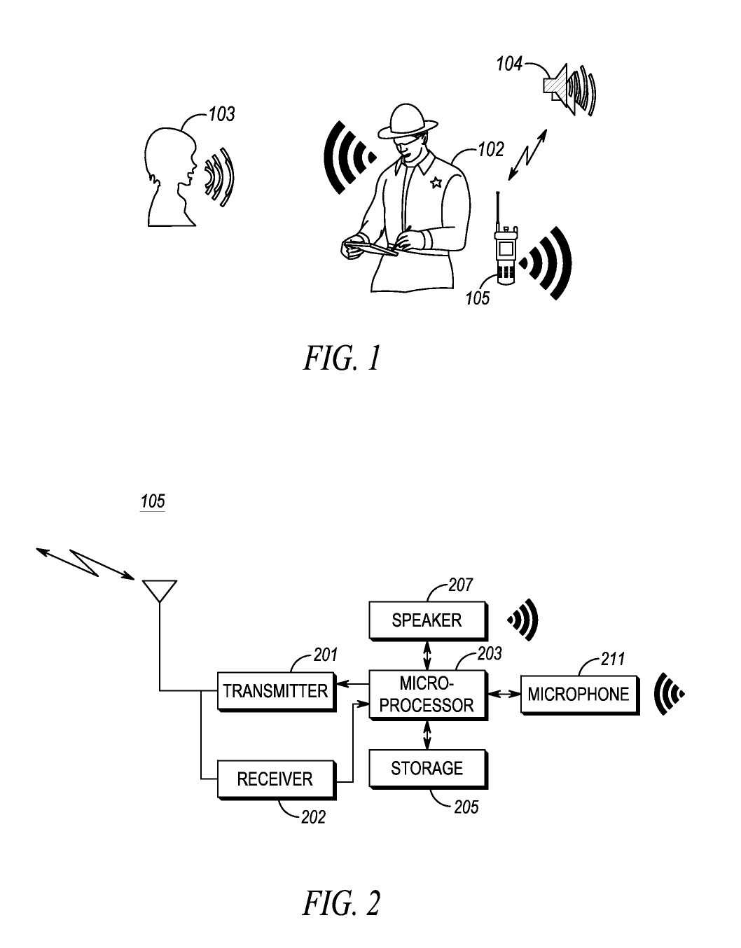

By muting a device as described above, a first responder will be able speak and listen for a response without being interrupted by their radio. This allows a first responder to concentrate on their job more effectively with more focus. For example, consider a situation where a paramedic is wearing a Bluetooth headset coupled to their radio. If the paramedic's radio receives a transmission when verbally communicating with a patient, the radio will not output any audible indication of the received transmission. Instead, the radio will store the communication for later playback. Once verbal communications have ceased for a predetermined period of time, the stored transmission will be played back to the paramedic. This is illustrated in FIG. 1.

As shown in FIG. 1 a first person 102 is verbally communicating with a second person 103. First person 102, may for example, be a paramedic, while second person 103 may be a patient. Device 105 is used by first person 102 and may comprise any portable electronic device, including but not limited to a handheld computer, a tablet computer, a mobile phone, a two-way radio, a media player, a personal digital assistant (PDA), or the like, including a combination of two or more of these items. During operation of device 105, device 105 will detect voice activity from nearby individuals (e.g., person 102 and/or person 103). When voice activity is detected, device 105 will cease outputting any audible signal. Instead, device 105 will store the audible signal internally until the voice activity has ceased for a predetermined amount of time. Once the voice activity has ceases for a predetermined amount of time, any stored transmissions will be output.

It should be noted that in many instances first person 102 may be wearing a wired or wireless headset 104. For example, headset 104 may comprise a Bluetooth headset that receives transmissions from radio 105. In addition to muting any internal speaker, radio 105 may also cease outputting any signal to headset 104 during detected voice activity. Thus, muting device 105 the cessation of any speech or other audible signals, whether to an external headset or an internal speaker.

As mentioned above, in the first embodiment, device 105 is muted upon the detection of any voice. However, in the second embodiment of the present invention, device 105 will only mute upon the detection of a particular individual's voice. So, for example, if device 105 detects the presence of the voice of first person 102, device 105 may be muted, however, if device 105 detects the presence of the voice of second person 103, the device may not be muted.

FIG. 2 is a block diagram of device 105 of FIG. 1. Device 105 comprises processor or logic circuitry 203 that is communicatively coupled with various system components, including transmitter 201, receiver 202, general storage component 205, speaker 207, and potentially, microphone 211. Only a limited number of system elements are shown for ease of illustration; but additional such elements may be included in the device 105.

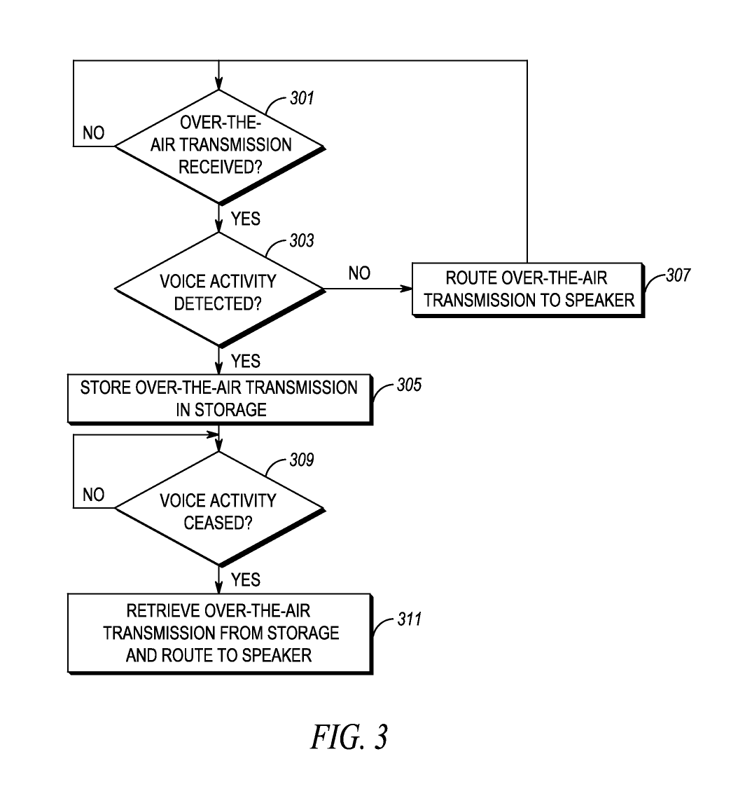

Processing device 203, sometimes referred to as logic unit 203 or logic circuitry 203, may be partially implemented in hardware and, thereby, programmed with software or firmware logic or code for performing functionality described in FIG. 3; and/or the processing device 203 may be completely implemented in hardware, for example, as a state machine or ASIC (application specific integrated circuit). Storage 205 can include short-term and/or long-term storage of received transmissions. These received transmissions preferably comprise voice transmissions, however, other audible information may be stored as well. Storage 205 may further store software or firmware for programming the processing device 203 with the logic or code needed to perform its functionality.

Speaker 207 converts an electrical signal to human-audible sound waves, while microphone 211 converts human-audible sound waves to an electrical signal. Transmitter 201 and receiver 202 are common circuitry known in the art for communication utilizing a well known communication protocol, and serve as means for transmitting and receiving messages. For example, receiver 202 and transmitter 201 may be well known long-range transceivers that utilize the APCO 25 (Project 25) communication system protocol. Other possible transmitters and receivers include, IEEE 802.11 communication system protocol, transceivers utilizing Bluetooth, HyperLAN protocols, or any other communication system protocol. In a preferred embodiment transmitter 201 and receiver 202 utilize both the APCO 25 communication system protocol and the Bluetooth communication system protocol. Although transmitter 201 and receiver 202 are shown in FIG. 2 as a single transmitter and receiver, one of ordinary skill in the art will recognize that both transmitter 201 and receiver 202 may actually comprise multiple transmitters and receivers, each capable of transmission and reception utilizing a particular communication system protocol.

During operation of device 105, receiver 202 will be periodically receiving over-the-air communications. These over-the-air communications preferably comprise wireless communication signals transmitted in accordance with any number of communication system standards. The received signals are appropriately processed and output to speaker 207. As discussed above, the received signals may alternatively processed and output to Bluetooth transmitter 201 for transmission to a Bluetooth speaker (not shown in FIG. 2).

Microphone 211 receives audible signals from the local environment and supplies these signals to logic circuitry 203. Logic circuitry 203 receives the audible signal and runs a voice-activity detection algorithm on the received signals to detect the presence of human voices. Voice activity detection (VAD), also known as speech activity detection or speech detection, is a technique used in speech processing in which the presence or absence of human speech is detected. A representative VAD technique formulates a decision rule using instantaneous measures of the divergence distance between speech and noise. The different measures which are used in VAD methods include spectral slope, correlation coefficients, log likelihood ratio, cepstral, weighted cepstral, and/or modified distance measures.

In a first embodiment, logic circuitry 203 will output any transmissions received by receiver 202 to storage 205 upon the detection of voice activity. These stored transmissions are then output to speaker 207 or Bluetooth transmitter 201 when speech is not detected by logic unit 203 for a predetermined period of time (e.g., 5 seconds). Thus, in the first embodiment of the present invention, the detection of any speech signal causes audible transmissions to cease, with these transmissions being played back when speech is not detected.

In a second embodiment of the present invention instead of VAD being used, speaker-dependent speech recognition (SR) is utilized. More particularly, logic circuitry 203 is “trained” to recognize a particular user's voice. This training may involve an individual speaker reading sections of text into microphone 211. Logic circuitry 203 will analyze a person's specific voice and use it to fine-tune the recognition of that person's speech. The SR used is preferably voice dependent in that logic circuitry 203 attempts to identity of “who” is speaking, rather than what they are saying.

In the second embodiment, logic circuitry 203 will output any transmissions received by receiver 202 to storage 205 upon the recognition of a particular user's voice. These stored transmissions are then output to speaker 207 or Bluetooth transmitter 201 the particular user's voice is not detected by logic unit 203 for a predetermined period of time (e.g., 5 seconds). Thus, in the second embodiment of the present invention, the detection of only a particular user's speech signal causes audible transmissions to cease, with these transmissions being played back when speech is not detected. Thus, the detection of a first user's voice may cause all audible outputs to cease, while the detection of a second user's voice may not cause all audible outputs to cease.

FIG. 3 is a flow chart showing operation of the device of FIG. 2. The logic flow begins at step 301 where logic circuitry 203 determines if receiver 202 received an over-the-air transmission. If so, at step 303 logic circuitry 203 determines if voice activity has been detected. If voice activity has been detected, then the logic flow continues to step 305 where the over-the-air transmission is stored in storage 205, otherwise the logic flow continues to step 307 where the over-the-air transmission is routed to speaker 207 and/or a headset. At step 309 logic circuitry 203 determines if voice activity has ceased for a predetermined period of time, and if so the logic flow continues to step 311 where the over-the-air transmission is retrieved from storage and routed to a speaker, otherwise the logic flow returns to step 309.

As discussed above, the step of receiving the over-the-air transmission comprises the step of receiving an over-the-air voice transmission. For example, a public-safety officer, or a paramedic may receive an over-the-air voice transmission from a dispatch center. Additionally, as discussed above, the step of detecting voice activity may comprise the step of determining if a voice from any user was detected, or alternatively a voice from a particular user was detected. If the later is the case, the step of storing the over-the-air transmission comprises the step of storing the over-the-air transmission only when the voice activity from the particular user has been detected. In a similar manner, the step of sending the over-the-air transmission to the speaker would then comprise the step of sending the over-the-air transmission to the speaker when it has been determined that the voice activity from the particular user has ceased. As is evident, the step of detecting voice activity comprises the step of detecting voice activity from a source other than from within the over-the-air transmission.

The above-described system provides for an apparatus 105 comprising an over-the-air receiver 202 receiving an over-the-air transmission comprising a first voice (e.g., a voice of a dispatcher). Microphone 211 is provided for detecting the presence of a second voice (e.g., the voice of a public-safety officer). The first voice received within the over-the-air transmission is stored in storage 205 when the second voice activity has been detected. Logic circuitry 203 will determine if second voice activity has ceased for a predetermined period of time, and if so will send first voice received in the over-the-air transmission to a speaker 207. 11. As discussed, second voice activity may comprise a voice of any person, or alternatively may comprise a voice of a particular person. Additionally the speaker may comprise a headset or s a speaker internal to the apparatus.

In the foregoing specification, specific embodiments have been described. However, one of ordinary skill in the art appreciates that various modifications and changes can be made without departing from the scope of the invention as set forth in the claims below. For example, although the above description was given with device 105 storing transmissions internally, one of ordinary skill in the art will recognize that these transmissions may be stored externally, for example, at the dispatch center. Additionally, although the above description was given with device 105 muting communications, in an alternate embodiment of the present invention the volume may be lowered in a similar manner. Thus, instead of simply routing any received communications to storage when voice activity is detected, the received communications can also be routed at a very low volume to a speaker. With this in mind, the term mute may encompass substantially lowering a volume. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for muting a device, the method comprising the steps of:
receiving, via a receiver, an over-the-air transmission;
detecting voice activity;
storing the over-the-air transmission when the voice activity has been detected;
determining that voice activity has ceased for a predetermined period of time;
sending the over-the-air transmission to a speaker when it has been determined that the voice activity has ceased for the predetermined period of time.

2. The method of claim 1 wherein the step of receiving the over-the-air transmission comprises the step of receiving an over-the-air voice transmission.

3. The method of claim 1 wherein the step of detecting voice activity comprises the step of determining if any voice was detected.

4. The method of claim 1 wherein the step of detecting voice activity comprises the step of determining if a voice from a particular user was detected, and the step of storing the over-the-air transmission comprises the step of storing the over-the-air transmission only when the voice activity from the particular user has been detected.

5. The method of claim 4 wherein the step of sending the over-the-air transmission to the speaker comprises the step of sending the over-the-air transmission to the speaker when it has been determined that the voice activity from the particular user has ceased.

6. The method of claim 1 wherein the step of detecting voice activity comprises the step of determining if a voice from a particular user was detected, and the step of sending the over-the-air transmission to the speaker comprises the step of sending the over-the-air transmission to the speaker when it has been determined that the voice activity from the particular user has ceased.

7. The method of claim 1 wherein the step of sending the over-the-air transmission to the speaker comprises the step of transmitting the over-the-air transmission to a headset.

8. The method of claim 1 wherein the step of detecting voice activity comprises the step of detecting voice activity from a source other than within the over-the-air transmission.

9. A method for muting a device, the method comprising the steps of:
receiving an over-the-air transmission at a receiver at a two-way radio;
detecting voice activity with a microphone;
storing the over-the-air transmission in storage when the voice activity has been detected;
determining that voice activity has ceased for a predetermined period of time;
sending the over-the-air transmission to an internal speaker when it has been determined that the voice activity has ceased for the predetermined period of time.

10. An apparatus comprising:
an over-the-air receiver receiving an over-the-air transmission comprising first voice activity;
a microphone detecting the presence of second voice activity;
storage storing the first voice activity received within the over-the-air transmission when the second voice activity has been detected;
logic circuitry determining that second voice activity has ceased for a predetermined period of time sending the first voice activity received in the over-the-air transmission to a speaker.

11. The apparatus of claim 10 wherein second voice activity comprises a voice of any person.

12. The apparatus of claim 10 wherein second voice activity comprises a voice of a particular person.

13. The apparatus of claim 10 wherein the speaker comprises a headset.

14. The apparatus of claim 10 wherein the speaker comprises a speaker internal to the apparatus.
